(19) United States
(12) Patent Application Publication
(10) Pub. No.: US 2021/0173372 A1
(43) Pub. Date: Jun. 10, 2021

(54) CONTROL SYSTEM

(71) Applicant: Telefonaktiebolaget LM Ericsson (publ), Stockholm (SE)

(72) Inventors: Sándor RÁCZ, Cegléd (HU); János HARMATOS, Budapest (HU); Norbert REIDER, Tényö (HU); Geza SZABO, Kecskemet (HU)

(21) Appl. No.: 17/268,711

(22) PCT Filed: Aug. 17, 2018
(86) PCT No.: PCT/EP2018/072309

§ 371 Date: Feb. 16, 2021

(51) Int. Cl. G05B 19/05; H04L 12/851; H04L 1/18

(52) U.S. Cl. CPC G05B 19/056; H04L 47/2483; G05B 2219/15117; G05B 2219/15023; H04L 1/1812

(57) ABSTRACT

A node for wirelessly controlling devices of a collaborative device group in an industrial infrastructure. The node includes: an inspection unit configured to identify a packet data flow of packet data to be transmitted by the node to one of the devices of the collaborative device group to control the corresponding, respective device; and a scheduling unit coupled to the inspection unit. The scheduling unit is configured to schedule transmission of the packet data to the corresponding, respective device based on the identification, by the inspection unit, of the packet data flow.

### TECHNICAL FIELD

The present invention generally relates to industry automation process-aware scheduling over a wireless infrastructure, and in particular to a node, a system and methods for wirelessly controlling devices of a collaborative device group in an industrial infrastructure.

### BACKGROUND

According to current standardization efforts, for example in 3GPP Release 16, it can be expected that networks, for example 5G networks, will be able to efficiently support URLLC (ultra-reliable, low-latency communication) services. The framing structure of the radio may provide ˜100 μs scale TTI (transmission time interval), and together with the latency-optimized, flexible core network functions, a 1-10 ms scale user equipment-data network (UE-DN) latency may be guaranteed.

The above mentioned latency values may be low enough to support most of the Industry Automation (IA) use cases, for example factory automation (including Process Automation and Discrete Automation tasks), Robotized Factory Automation cells and assembly lines (for example car manufacturing), including mass production as well as limited number, diversified production.

Packet scheduling in communications has generally been limited for controlling a single user equipment. Prior art can be found, for example, in U.S. Pat. No. 9,295,040 B2 and in US 2018/0026891 A1.

However, there is generally the need for improvements of industry automation process-aware scheduling.

### SUMMARY

It has been realized that, so far, collaborative aspects of industry automation in which wireless specific considerations are taken into account have not yet been considered.

In a first aspect according to the present disclosure, there is therefore provided a node for wirelessly controlling devices of a collaborative device group in an industrial infrastructure, wherein the node comprises: an inspection unit configured to identify a packet data flow of packet data to be transmitted by the node to one of the devices of the collaborative device group to control the corresponding, respective device; and a scheduling unit coupled to the inspection unit, wherein the scheduling unit is configured to schedule a transmission of the packet data to the corresponding, respective device based on the identification, by the inspection unit, of the packet data flow.

The node as described herein therefore allows for industry automation process-aware scheduling over a wireless infrastructure by considering collaborative industry devices. Based on identified packet data flows, scheduling of packet data transmission is controlled and optimized for controlling the devices of the collaborative device group.

The node may, in some examples, be implemented as a network node, for example an access node, such as, but not limited to an eNB, gNB in RAN, or UPF in the core part.

It will be understood that the node may, in some examples, be implemented as a physical computing unit as well as a virtualized computing unit, such as a virtual machine, for example. It will further be appreciated that the node may not necessarily be implemented as a standalone computing unit, but may be implemented as components—realized in software and/or hardware—residing on multiple distributed computing units as well, such as in a cloud computing environment, for example.

Devices in the collaborative device group may generally refer to devices which can but should not be controlled in isolation from the other devices in the collaborative device group. In particular, the devices of the collaborative device group may solve (for example complex) tasks which may require operation of the devices in the collaborative device group in a collaborative manner.

Devices being comprised in a collaborative device group may therefore, in some examples, be understood as to the operations of the respective devices being dependent from each other. In particular, such dependency may, in some examples, refer to certain operations for a respective device being allowed or not being allowed dependent on one or more properties (for example operating properties) and/or operations and/or operation conditions and/or operation statuses of the other devices in the collaborative device group.

It may therefore be important to schedule transmission of the packet data to a corresponding, respective device of the collaborative device group based on the identified packet data flow so as to allow for an operation performed by one of the devices of the collaborative device group not being independent from one or more properties (for example operating properties) and/or operations and/or operation conditions and/or operation statuses of the other devices in the collaborative device group.

In some variants of the node, the scheduling unit is configured to schedule transmissions of respective packet data to corresponding, respective devices of the collaborative device group based on a comparison of the packet data flow identification of respective packet data flows used to control the corresponding, respective devices. The node may hereby be configured to control respective packet data transmissions to more (in particular all) devices of the collaborative device group. This may allow for full control of the devices of the collaborative device group without an operation of one or more of the devices being in conflict with one or more properties (for example operating properties) and/or operations and/or operation conditions and/or operation statuses of the other devices in the collaborative device group.

In some example implementations of the node, the inspection unit is a shallow packet inspection (SPI) unit. It will hereby be understood that there may be multiple headers for data packets, such as Internet Protocol (IP) packets. In some examples, a network equipment may only need to use the first of these headers (the IP header) for certain operations, but use of the second header may be considered, for example, in such a shallow packet inspection.

In some variants, the node is configured to transmit the packet data to one or more user equipments via which the devices of the collaborative device group are controlled. This may allow for the node to be in communication with one or more user equipments which may then control the devices of the collaborative device group based on the packet data received from the node. In some examples, the one or more user equipments are integral to, i.e. part of a system which also comprises the node. The one or more user equipments may, in some example implementations, be configured to perform the functions generally as described herein with respect to the node(s) and system(s).

It is hereby to be noted that a user equipment may be in communication with and control of, based on the received packet data from the node, one or more devices of the collaborative device group, as will be outlined further below.

In some examples, the one or more user equipments are comprised in (i.e. part of) example implementations of a system comprising the node. Additionally or alternatively, the devices of the collaborative device group may, in some examples, be comprised in (i.e. part of) example implementations of a system comprising the node.

In some example implementations of the node, in case each one of the devices of the collaborative device group is associated with a corresponding, respective one of a plurality of radio bearers via which the corresponding, respective packet data is transmitted to the corresponding, respective device, the identification of the packet data flow to the corresponding, respective device is based on the corresponding, respective one of the plurality of radio bearers. This may allow for precise identification of the packet data flow to a particular one of the devices of the collaborative device group.

In a variant of the node, in case at least two of the devices share a single radio bearer, the identification of the packet data flow to a corresponding, respective one of the devices is based on one or both of: a detection of an identifier which is carried by a control frame, wherein each one of the devices of the collaborative device group is associated with a corresponding, respective identifier; and a detection of a destination address of a corresponding, respective one of the devices of the collaborative device group. This may allow, in particular, for identification of the packet data flow for controlling a particular one of the devices of the collaborative device group.

In some example implementations of the node, the inspection unit is further configured to determine a characteristic of the identified packet data flow, and wherein the scheduling unit is configured to schedule the transmission of the packet data to the corresponding, respective device based on the determined characteristic of the identified packet data flow. This may allow for a more precise scheduling of the transmission of the packet data to the corresponding, respective device as the characteristic of the identified packet data flow is taken into consideration in the scheduling procedure.

In some variants of the node, the characteristic comprises a communication cycle length of a communication between the node and the corresponding, respective device. The communication cycle length may hereby be set on a per-device basis, i.e. different devices may have different communication cycle lengths. The communication cycle length may hereby be taken into account in the industry automation process. Taking into account the communication cycle length when scheduling packet data transmission may allow for enhanced control of transmission scheduling for improved control of the devices of the collaborative device group.

In some example implementations, the node is configured to determine an operating dependency between the devices, and wherein the scheduling of the transmission of the packet data to the corresponding, respective device is based on the operating dependency. The operating dependency may hereby relate to one or more of physical properties of the devices, operating properties (for example physical operating capabilities) and operating statuses of the devices of the collaborative device group.

In some variants, a programmable logic controller is coupled to the scheduling unit via the inspection unit, wherein the programmable logic controller is configured to control the devices of the collaborative device group through control frames, and wherein the node is configured to determine the operating dependency between the devices based on an inspection of a source address of the control frames. This may allow for an improved simultaneous control of the collaborative devices. Furthermore, this may be particularly advantageous as, in some examples, no feedback may be required from the devices so as to take into account the current operating statuses when scheduling subsequent transmissions, but instead, the control frames, and in particular the source address of the control frames may be analyzed for improved simultaneous control of the collaborative devices.

In some variants, the node further comprises an application programming interface coupled to the inspection unit and the scheduling unit, wherein the operating dependency is set (i.e. set-able/determinable) via the application programming interface. This may allow, in some examples, for external control of the operating dependency between the devices of the collaborative device group.

In some example implementations of the node, at least two of the devices are controlled by different, respective programmable logic controllers, and wherein the setting, via the application programming interface, of the operating dependency between the devices comprises simultaneously controlling the programmable logic controllers. A single scheduling unit may hereby be used, or a plurality of scheduling units may be used, whereby the scheduling units may be coupled to each other or in communication with each other.

In some variants, the node is configured to prioritize transmission of a first packet data for a first device control operation (for example to control a first device of the collaborative device group) over transmission of a second packet data for a second device control operation (for example to control a second device of the collaborative device group, or to control the first device) during the packet data transmission scheduling when a first priority of the first device control operation is higher than a second priority of the second device control operation. The first device control operation may hereby be more important to achieving the overall task or goal being performed or aimed at by the collaborative device group. It may therefore be guaranteed that the first device control operation takes precedence over the second device control operation.

In some example implementations, the node further comprises a packet data flow database coupled to the inspection unit and the scheduling unit, wherein the packet data flow database is configured to receive information relating to the packet data flow from the inspection unit and to store the information, and wherein the scheduling unit is configured to schedule the transmission of the packet data based on the information stored in the packet data flow database. Scheduling of transmission or transmissions of packet data may hereby be based on previously obtained information stored in the packet data flow database, which may, in some examples, allow refining one or both of subsequent packet data flow identification and packet data transmission scheduling. The packet data flow database may hereby be configured to store one or more of the flow identifier, a communication cycle length, a status of a previously frame, a flow dependency and a priority of one or both of a last frame or frames and a current frame or frames.

In some example implementations, the node further comprises a radio transmission feedback control unit coupled to the scheduling unit and the packet data flow database, wherein the radio transmission feedback control unit is configured to provide a control frame status, associated with a served control frame, to the packet data flow database for storage in the packet data flow database, and wherein the scheduling unit is configured to schedule subsequent transmission of packet data based on the stored control frame status. Further refinement of one or both of the subsequent packet data flow identification and the packet data transmission scheduling may hereby be achieved.

In some variants of the node, the control frame status comprises information relating to one or both of (i) a said transmission having been successful and (ii) a hybrid automatic repeat request which is to be applied for packet data re-transmission. This information may be taken into account when scheduling subsequent packet data transmission(s), in particular by deriving from this information a priority for subsequent packet data transmission(s).

In some example implementations of the node, the packet data flow database is configured to store information relating to a transmission priority of the transmission of the packet data, and wherein the scheduling unit is configured to schedule the transmission based on the transmission priority. This may allow for an advantageous control of the devices of the collaborative device group, for example in case certain transmissions are of a higher priority than others (for example in view of the overall goal aimed to be achieved by the devices of the collaborative device group).

In some variants, the transmission priority is associated with a said device control operation priority.

In some example implementations, the transmission priority of the subsequent packet data transmission is based on the control frame status which has been obtained previously. The control frame status may hereby be stored in the packet data flow database.

In some variants of the node, in case the devices are served by a single user equipment, the scheduling unit is configured to schedule the transmission of control frames for corresponding, respective devices of the collaborative device group in a single radio frame. In some example implementations, in case the devices are served by two or more corresponding, respective user equipments, the scheduling unit is configured to schedule transmission of control frames for the respective devices in corresponding, respective control frames at the same time.

In some variants of the node, in case a said control frame of one of the devices is delayed, the scheduling unit is configured to determine whether non-delayed control frames are to be transmitted as scheduled or are to be transmitted at a later point of time. This determination may be based, for example, on a priority of one or more of the non-delayed control frames, in particular in view of the overall goal which may be desired to be achieved by the collaborative device group.

In some example implementations, the node is configured to compare a HARQ execution time with a communication cycle length of the packet data flow and to stop a HARQ execution when it is determined that the HARQ execution time exceeds the communication cycle length of the packet data flow. In some examples, a new transmission of a packet data may be scheduled.

In a related aspect, there is provided a system which comprises two or more said nodes, wherein each of the nodes is configured to transmit packet data to one or more corresponding, respective user equipments via which the system controls the devices of the collaborative device group. The two are more nodes may hereby, in some examples, be controlled via a single programmable logic controller. In some examples, the two or more nodes are in communication with each other to synchronize packet data transmissions from the nodes to the corresponding, respective user equipments. Processing, control and scheduling resources of one of the nodes may hereby be used in order to control a subset of the devices of the collaborative device group, in particular via a limited number of one or more user equipments.

In some example implementations of the system, a first one of the nodes serves a first one of the devices and a second one of the nodes serves a second one of the devices, and wherein the synchronization is based on information, provided to the first node and the second node, related to a device dependency between the first device and the second device. Improved synchronization for controlling the devices of the collaborative device group may hereby be achieved.

In some examples, the synchronization comprises exchanging scheduling status information between the two or more nodes. This may allow for enhanced scheduling of packet data transmission via an improved synchronization of the transmission from the two or more nodes.

In some example implementations of the node or the system, the scheduling unit is configured to initiate dropping a currently scheduled packet data transmission if a waiting time for the packet data transmission of a scheduled packet data exceeds a threshold. A subsequent packet data transmission may then instead be scheduled.

In some variants, the node or system is configured to determine if the currently scheduled packet data transmission is to be dropped based on a waiting time-to-communication cycle length ratio. A currently scheduled packet data transmission may then in particular be dropped if the waiting time exceeds the communication cycle length.

In some example implementations of the node or system, the currently scheduled packet data transmission is dropped when a HARQ execution time exceeds a communication cycle length, and wherein the node or system is configured to stop the HARQ execution when the currently scheduled packet data transmission is dropped. This may allow, in some examples, for scheduling subsequent packet data transmission(s).

According to a related aspect of the present disclosure, there is provided a system for wirelessly controlling devices of a collaborative device group in an industrial infrastructure, wherein the system comprises a plurality of nodes, wherein each of the nodes is configured to control one or more corresponding, respective user equipments via which the system is configured to control the devices, and wherein the nodes are in communication with each other and are configured to synchronize transmission of corresponding, respective packet data to the corresponding, respective user equipments to simultaneously control the devices of the collaborative device group. Synchronized transmission of corresponding, respective packet data to corresponding, respective user equipments to simultaneously control the devices of the collaborative device group may, in some examples, allow for processing, controlling and scheduling resources of one of the nodes which is used in order to control a subset of the devices of the collaborative device group, in particular via a limited number of one or more user equipments.

In some example implementations of the system, the synchronization comprises informing, by a first one of the nodes, the other one or more nodes of its readiness for packet data transmission and acknowledging, by the other one or more nodes, their readiness or a new time for packet data transmission. Synchronization of packet data transmission for simultaneous control of the devices of the collaborative device group may hereby be improved.

In some variants, the synchronization comprises one or more of: an exchange request, from one of the nodes to another node, and a corresponding exchange response, from the other node to the one node, for exchanging collaborative device information used for transmission synchronization, in particular wherein the collaborative device information comprises packet data flow information; a database synchronization of databases of the nodes based on the collaborative device information; an exchange between the nodes of a frame scheduling action request and a corresponding frame scheduling action response; and an exchange between the nodes of a frame scheduling status information and a corresponding frame scheduling status information acknowledgement.

According to a related aspect of the present disclosure, there is provided a method for wirelessly controlling devices of a collaborative device group in an industrial infrastructure, the method comprising: identifying a packet data flow of packet data to be transmitted to one of the devices of the collaborative device group to control the corresponding, respective device; and scheduling a transmission of the packet data to the corresponding, respective device based on the identification of the packet data flow.

Variants of the method generally relate to performing functions as outlined above with regard to example implementations and variants of the described node and system.

In a further related aspect of the present disclosure, there is provided a method for wirelessly controlling devices of a collaborative device group in an industrial infrastructure, wherein the method comprises: synchronizing transmission of packet data from a plurality of nodes to corresponding, respective user equipments; and simultaneously controlling the devices of the collaborative device group based on the synchronized transmission.

Variants of the method generally relate to performing functions as outlined above with regard to example implementations and variants of the described node and system.

There is further provided a computer program product comprising program code portions for performing one or both of the methods as outlined above when the computer program product is executed on one or more computing devices. The computer program product may, in some examples, be stored on a computer-readable recording medium.

### BRIEF DESCRIPTION OF THE DRAWINGS

These and other aspects of the present disclosure will now be further described, by way of example only, with reference to the accompanying figures, wherein like reference numerals refer to like parts throughout, and in which:

FIG. 1 shows a schematic illustration of a system according to some example implementations as described herein;

FIG. 2 shows a structure of a flow information database according to some example implementations as described herein;

FIG. 3 shows a schematic illustration of a system according to some example implementations as described herein;

FIG. 4 shows a flowchart of a method according to some example implementations as described herein;

FIG. 5 shows a schematic illustration of a system according to some example implementations as described herein;

FIG. 6 shows a schematic illustration of a node according to some example implementations as described herein;

FIG. 7 shows a flowchart of a method according to some example implementations as described herein; and

FIG. 8 shows a flowchart of a method according to some example implementations as described herein.

### DETAILED DESCRIPTION

In the description outlined herein, for purposes of explanation and not limitation, specific details may be set forth, such as a specific network environment in order to provide a thorough understanding of the technique disclosed herein. It will be apparent to one skilled in the art that the technique may be practiced in other embodiments that depart from these specific details. Moreover, while the following embodiments may be primarily described for Long Term Evolution (LTE) and 5G implementations, it is readily apparent that the technique described herein may also be implemented in any other wireless communication network, including a Wireless Local Area Network (WLAN) according to the standard family IEEE 802.11 (for example IEEE 802.11a, g, n or ac; also referred to as Wi-Fi) and/or a Worldwide Interoperability for Microwave Access (WiMAX) according to the standard family IEEE 802.16.

Moreover, those skilled in the art will appreciate that the services, functions, steps and units explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, for example, including an Advanced RISC Machine (ARM). It will also be appreciated that, while the following embodiments are primarily described in context with methods, devices and systems, the invention may also be embodied in a computer program product as well as in a system comprising a computer processor and memory coupled to the processor, wherein the memory is encoded with one or more programs that may perform the services, functions, steps and implement the units disclosed herein.

Although ultra-low latency is a key factor to support the realization of an Industry Automation system (for example a robotized assembly line) by using a 3GPP compliant wireless infrastructure (for example 4G or 5G networks), by itself, the ultra-low latency does not guarantee the proper operation of the system. This is because the Industry Automation (IA) system may have several important characteristics beyond the low latency, which should be considered by the wireless infrastructure, but these are partly or completely missing today.

Considering deterministic communication (aka bounded delay), the IA systems may use cycle-based communication, which may mean that (ultra)-low latency in itself may not be enough, but deterministic (or bounded) latency may be required with very low (or at least controlled) jitter. Since deployments are nowadays typically local and use wired infrastructure the above requirement is easily fulfilled. However, in the case of a 3GPP compliant wireless infrastructure, much (significantly) higher jitter (due to latency variance bringing in by core network functions as well as jitter on radio caused by radio framing, scheduling delay, re-transmission, etc.) may need to be considered. Even if a robust radio channel is used, in a factory environment very frequent and significantly changes of radio parameters may need to be considered (for example due to moving robotic arms, moving large size workpieces, such as car body pieces). Otherwise, the radio framing in itself may bring about a delay variance, which may be at least one order higher than in current Factory Automation deployments.

Even in the case of ultra-low latency, the above factors may make it difficult to guarantee the determinism in order to support the cycle-base communication. It may cause minor or even major uncertainties in the IA process (since a delayed packet may be considered a lost packet) and in some cases the IA process may be degraded or even collapsed, which may mean a quite unreliable operation.

Regarding support of collaborative devices, since the robotized cells may need to solve complex tasks, the importance of collaboration among devices (for example robots) may increase. This may mean that there may be a strong dependency among the operation of the collaborative devices and this may need to be supported by the underlying communication system (this may mean for example that the communication cycles of the collaborative devices may need to be synchronized in order to get the control packets at the same time, to guarantee the solving of the correspondent collaborative task properly). By using wired infrastructure, this requirement may also be easily fulfilled, since the programmable logic controller (PLC) (or PLCs) may generate the adequate control packets at the same time and, since the latency of the wired infrastructure may be negligible, the collaborative devices may get the control packet practically at the same time.

However, by using a wireless infrastructure, it may not be guaranteed that the packets sent at the same time by the source will arrive at the same time to the destinations due to various reasons, such as scheduling, effects of re-transmission, and multiple user equipments (UEs)-multiple base stations scenarios.

Regarding scheduling, the control frames of the collaborative devices may need to be scheduled at the same time (for example in the same radio frame), as otherwise the execution of the IA process may be degraded. If at least one of the collaborative control frames cannot be scheduled or is lost on the radio channel, the collaborative task cannot, in some examples, be executed.

Regarding the effect of a re-transmission on radio (HARQ), practically, in almost all phases of an IA process, loss of one frame may be tolerated. However, the cyclic-based communication should be maintained. Consequently, if a control frame may need to be re-transmitted, but in the meantime the next control frame arrives, then this latest control frame should be scheduled at the right time (according to the communication cycle), instead of a re-transmission of the previous one. The endorsement of the above requirements in the scheduling may not be possible without awareness of the IA process.

In a multiple UEs—multiple base stations scenario, due to the optimization of the propagation of radio signal, it may happen that collaborative devices are served by different UEs. For the case of a single base station, when the different UEs are connected to the same base station, the dependency among UEs should be considered in the scheduling, which is not supported in the art. In the case of multiple base stations, it may happen that different UEs are served by different base stations and in this case the above mentioned requirements can only be fulfilled if there is coordination among the corresponding base stations, which feature is currently not implemented in the art.

Described herein is a set of new entities (set of functions) provided by the wireless infrastructure, which makes it possible to realize an Industry Automation system over the wireless infrastructure in an efficient and robust way.

In the present disclosure, entities may be able to identify device flows and determine flow characteristics as well as the dependencies among collaborative devices (automatic exploration of collaborative device groups).

A scheduling support entity which is aware of the flow-level characteristics of the IA process is described which may assist the scheduling of transmissions based on this information.

Support of collaborative devices for a single UE, multiple UEs and multiple base station deployment cases is described.

Based on an automatized (self-learning) scheduling plan, it is possible to provide information if a new IA device with a certain communication cycle can be served without service degradation of the already connected IA devices.

The system may be configured over an application programming interface.

The functions described herein may be implemented in the 3GPP RAN and Core node(s) (for example eNB, gNB in RAN, or UPF in the Core part), so only the network nodes and functions may be impacted, without a potential impact on the UE side. Furthermore, the IA-related nodes/functions (for example PLC) may not be impacted or merely in a minor way.

The functions, devices, systems and implementations described herein may be used as a proprietary solution. However, at least some of them may be standardized, in which case these could be considered as standard blocking features.

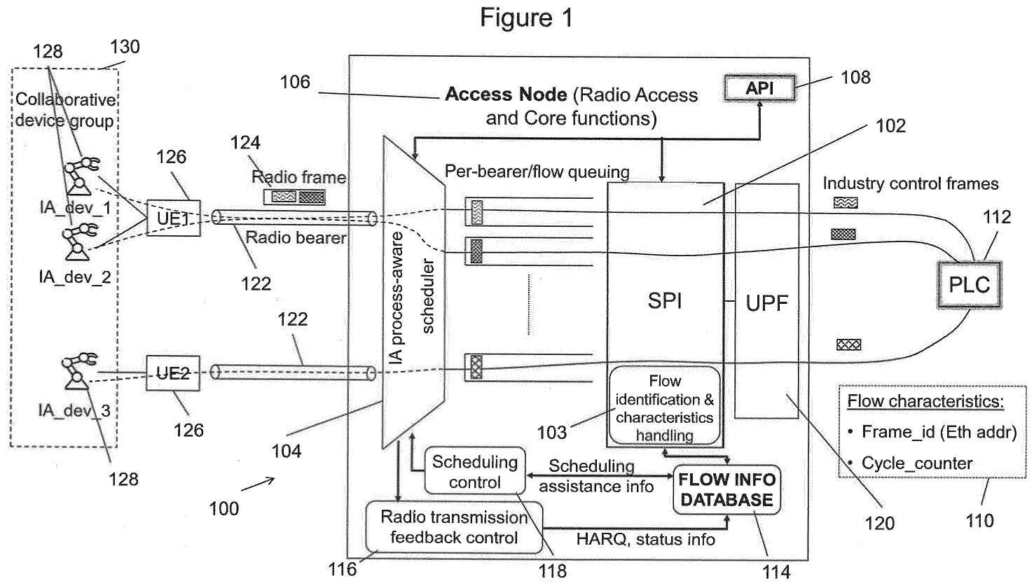

FIG. 1 shows a schematic illustration of a system 100 according to some example implementations as described herein.

The figure shows, in this example, a local deployment case, whereby in view of the aim to achieve low latency, the required RAN and Core Network functions are integrated, in this example, into a single node, called Access Node (AN). It is to be understood that this is not a requirement, i.e. the placement of RAN and Core network functions is not restricted.

In this example, the node 106 comprises an inspection unit 102 and a scheduling unit 104. In this example, the inspection unit 102 is a shallow packet inspection unit. The scheduling unit 104 is, in this example, an IA process-aware scheduler.

In this example, a programmable logic controller 112 is used in order to send industry control frames to user equipments 126 via the inspection unit 102 and the scheduling unit 104. In this example, the user equipments 126 are used to control devices 128 of a collaborative device group 130.

In this example, a first user equipment controls two devices, whereas a second user equipment controls a single device. It will be appreciated that other constellations and scenarios are possible.

In this example, the inspection unit 102 is configured to identify flow characteristics 110, including, in this example, a frame_id (and Ethernet address) and a cycle counter.

In this example, an optional user plane function (UPF) 120 is provided in between the programming logic controller 112 and the inspection unit 102.

In this example, the inspection unit 102 comprises a flow identification and characteristics handling unit 103. This allows the inspection unit 102 to identify a packet data flow and to determine one or more characteristics of the packet data flow and/or packet data.

In this example, the industry control frames are provided via the inspection unit 102 to the scheduling unit 104 each in a single radio bearer. The industry control frame flows may hereby be queued before being transmitted via the user equipments 126 to the devices 128.

In this example, an application programming interface 108 is coupled to the inspection unit 102 and the scheduling unit 104. Various functions are provided via the application programming interface 108, as outlined above and below. In particular, the application programming interface 108 may be used in order to set an operating dependency between the devices 128 which may then be used by the system 100 during the packet data flow identification and/or the transmission scheduling.

In this example, the access node 106 provides for radio access and core functions.

The node 106 comprises, in this example, a packet data flow database 114 which is coupled to the inspection unit 102. In this example, the packet data flow database 114 is further coupled to a scheduling control 118 for exchanging scheduling assistance information.

The scheduling control 118 is coupled to the scheduling unit 104 in order to provide the scheduling unit 104 with information contained in the packet data flow database 114.

In this example, packet data flow database is coupled to the inspection unit 102 in order for information obtained via the inspection unit 102 to be stored in the packet data flow database 114.

Information stored in the packet data flow database 114 may hereby be used for subsequent packet data flow identification by the inspection unit 102 and/or for subsequent transmission scheduling by the scheduling unit 104.

In this example, node 106 further comprises a radio transmission feedback control unit 116 which is coupled to the packet data flow database 114 and the scheduling unit 104.

In this example, the radio transmission feedback control unit 116 is configured to provide a control frames status, associated with a served control frame, to the packet data flow database 114 for storage in the packet data flow database 114. In this example, status information regarding a control frame status is provided by the radio transmission feedback control unit 116 alongside with HARQ information.

In this example, control frames are provided to two user equipments 126 in radio frames 124 via two radio bearers 122. It will be appreciated that other constellations and scenarios are possible.

As can be seen from the above, FIG. 1 outlines the general concept of the IA process-aware scheduling as described herein.

In this example, the AN consists of RAN functions (for example a base station), including an IA process-aware scheduler, a per-bearer or per-flow queuing mechanism, a Shallow Packet Inspection (SPI) function and the optional User Plane Functions.

Regarding the per-flow queuing mechanism, one UE may handle as many bearers as the number of connected devices. However, for example 3GPP Rel. 16 considers a single bearer-per-UE concept. In this case, the UE may act as an L2 bridge and only one bearer may be established between the UE and the base station. The solution described herein may be implemented in both approaches.

Regarding the shallow packet inspection function, the shallow packet inspection unit may be implemented as a UPF.

Regarding the optional user plane functions, a tunneling endpoint may be provided if there is a tunnel between the PLC and the AN. Additionally or alternatively, Ethernet 3GPP bearer-handling functions and other functions may be implemented.

As outlined above, an application programming interface is used in this example in order to provide additional information for the inspection unit 102.

In this example, as outlined above, the scheduling unit 104 contains a flow identification and characteristics handling unit 103 which is responsible for flow identification and determination of the flow characteristics.

The flow characteristics and current control frame status-related information are, in this example, stored in a packet data flow database 114.

Scheduling Logic may provide assistance information for the scheduling on the basis of the information stored in the packet data flow database 114.

As outlined above, radio transmission feedback control provides information about the status of the currently served control frames.

The AN may be connected to the Programmable Logic Controller (PLC) by using any underlying network.

An industry assembly cell may be served by a single or multiple UEs and the collaborative IA devices could be connected to the UE(s) without any limitation. An industry assembly cell may be served by a single or multiple ANs. Collaborative devices may be served by single UE or multiple UEs and these UEs may be connected to a single AN or multiple ANs.

### Flow Identification

For supporting an IA process-aware scheduling, a key factor may be the proper identification of the control flow of a given IA device. In a one bearer—one IA device case, this task may be performed on the basis of the bearer.

In the case when traffic of multiple IA devices are aggregated on a single bearer, the task may be more complex and flows may be identified in the following ways.

In a first example implementation, the device identifier-based identification is implemented. In the case of Industry Automation protocols (for example PROFINET), each device may have an identifier which is carried by the control frame such that it can be detected by the inspection unit. In the case of PROFINET, this is the Frame_id, which may identify a flow towards a given IA device.

In a second example implementation, the device address-based aggregation is implemented. The inspection unit may hereby obtain the destination (Ethernet) address of a given device, such that frames belonging to a given flow may be identified.

### Flow Characteristics—Communication Cycle

When the flows are identified, the next step may be the determination of the communication cycle length, which is an important characteristic of a flow, and hence an important characteristic of an IA process. It will be appreciated that the communication cycle length may have already been determined prior to the flow identification, for example based on data stored in the packet data flow database.

The communication cycle length may be set on a per-flow (per-device) basis, so different devices may have different cycle lengths.

In the case of the PROFINET protocol, each frame contains a file, called Cycle_counter, which may be used to identify the order of frames, but based on the Cycle_counter values of two consecutive frames, the length of the communication cycle of a flow may also be calculated. If cycle lengths of each of the flows are determined, then the complete factory cell, AN or even network level communication plan may be calculated.

In some example, the cycle length is equal to 31.25 μsec×(difference of cycle counter of two consecutive frames).

In the construction of the communication plan, it may be considered that the base stations are synchronized (on a has scale granularity).

An alternative may be to use the application programming interface via which the AN may be informed about the communication plan.

In this phase, the dependencies among devices (for example collaborative device groups) are identified. Since a collaborative device group may be controlled by a common PLC entity, the group may be recognized by inspecting the source address of the control frames.

Another way is to use the application programming interface via which the device dependency or dependencies may be configured.

The application programming interface-based configuration may also be applied if collaboration exists, such that the devices are controlled by different programmable logic controllers.

In addition, the application programming interface may also be used to set a part of an IA process (for example a precise robotic arm movement) to be critical such that control packets of this phase should be treated with high importance. In this way, optionally, a two- or multi-level frame prioritization may also be supported.

### Flow Information Database

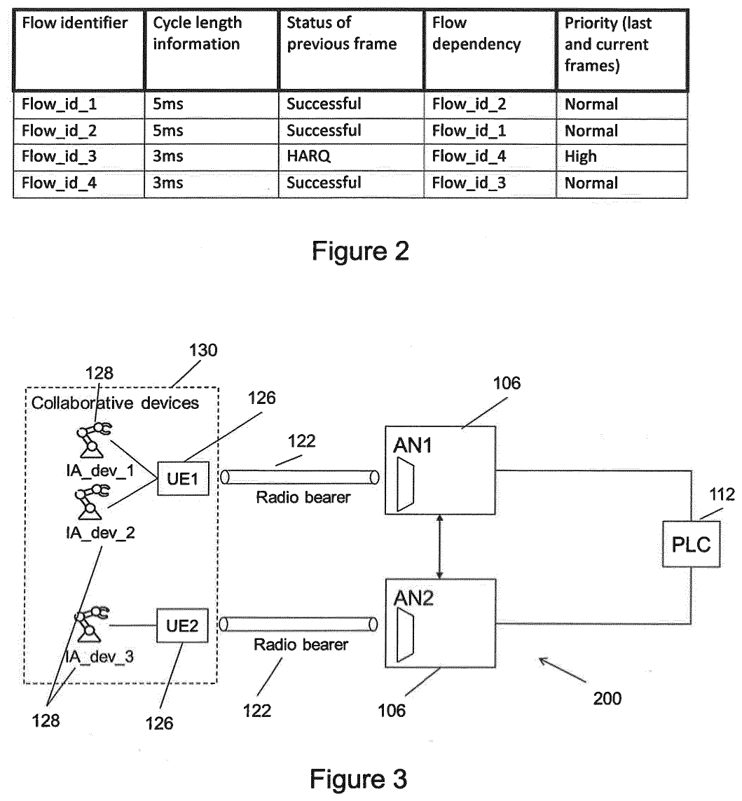

Based on the above information, the packet data flow database may be created, in some examples, with the flow information shown in FIG. 2.

The table in FIG. 2 shows an example structure of the packet data flow database.

In this example, the database contains cycle length-related information for each flow handled by the given AN, which is used to determine when the next control frame belonging to the flow is expected to arrive.

The database contains, in this example, also the status information of the previous frame (for example transmitted successfully, HARQ is required, etc.), which is provided by the radio transmission feedback control unit.

In order to support the collaborative devices, the device dependencies are, in this example, also stored in the packet data flow database together with the priority of the (latest and expected current) frames.

The priority may, in some examples, reflect the critical and less critical part of the IA process, which may be set by using the application programming interface. Furthermore, the priority of the expected next frame may be influenced by the transmission status of the last frame (for example if a control frame is lost, then the next frame control plane may be prioritized for scheduling). This process may be handled by the radio transmission feedback control unit. If one control frame of a device which belongs to a collaborative device group needs to be re-transmitted, then the frame may also be prioritized.

### Support of the IA Process-Aware Scheduling

The IA process-aware scheduling may be supported by the scheduling control entity (scheduling unit) by considering the flow-related information (for example the status of previous frame, the cycle length and the device collaboration if it exists) of a given control frame that is waiting for the scheduling and optionally other IA process-related information configured via the application programming interface of the AN.

Several examples for the scheduling support will be listed. However, other support mechanisms may be deployed in the scheduling unit.

### Support of Device Collaboration for a Single User Equipment

In this deployment case, a group of collaborative devices are served by a single UE.

If all control frames for a group of collaborative devices have arrived, then these control frames may be enforced to schedule in the same radio frame.

All other control frames that are destined to industry devices handled by a single UE may be scheduled in single radio frame in order to increase radio spectral efficiency.

If the control frames of several devices are delayed, then the scheduling unit may provide information if the available frames should be scheduled or can wait to be transmitted. The scheduling unit may propose the strategy based on the flow characteristics and frame status information obtained from the packet data flow database.

In the case of an unsuccessful transmission, the scheduling unit may propose HARQ execution or waiting for the arrival of the next control frame(s).

### Support of Device Collaboration Over Multiple User Equipments

In this deployment case, a group of collaborative devices is served by multiple UEs, but all the involved UEs are connected to the same AN.

If all control frames for a group of collaborative devices have arrived, then the involved UEs (that serve the devices) are scheduled at the same time.

If the control frames of several devices of a collaborative device group are delayed, then the available frames are proposed to be scheduled or delayed by the scheduling unit, depending on the flow characteristics and the current control frame status of the devices belonging to the collaborative device group.

Regarding HARQ re-transmission for collaborative devices, the HARQ execution time and communication cycle length of all involved flows may be compared and if the HARQ execution time exceeds, in this example, the cycle length of any flow, then HARQ execution is forced to stop and the next group of control frames is planned to be scheduled. If next control frames of all involved devices have arrived before the end of the HARQ execution time, then HARQ is forced to stop and the next group of control frames will be scheduled.

### Support of Device Collaboration Over Multiple ANs

In several deployment cases, it is possible that the collaborative devices are connected to different UEs and these UEs are served by different ANs (base stations). A reason behind this may be the limitation in the radio wave propagation. In order to achieve the same level of the above-described IA process-awareness, an additional coordination may be required among the ANs that serve UEs, which handle collaborative devices.

FIG. 3 shows an example system 200 for this case.

In this example, a single programmable logic controller 112 is coupled to two ANs. Each of the ANs serves a corresponding, respective user equipment via a corresponding, respective radio bearer.

In this example, a first user equipment is used to serve two devices of the collaborative device group, whereas a second user equipment is used to serve a single device of the collaborative device group. It will be appreciated that other constellations and scenarios are possible.

The support of collaborative devices can also be solved in this case, but an information exchange may be required among the ANs which may serve collaborative industry devices.

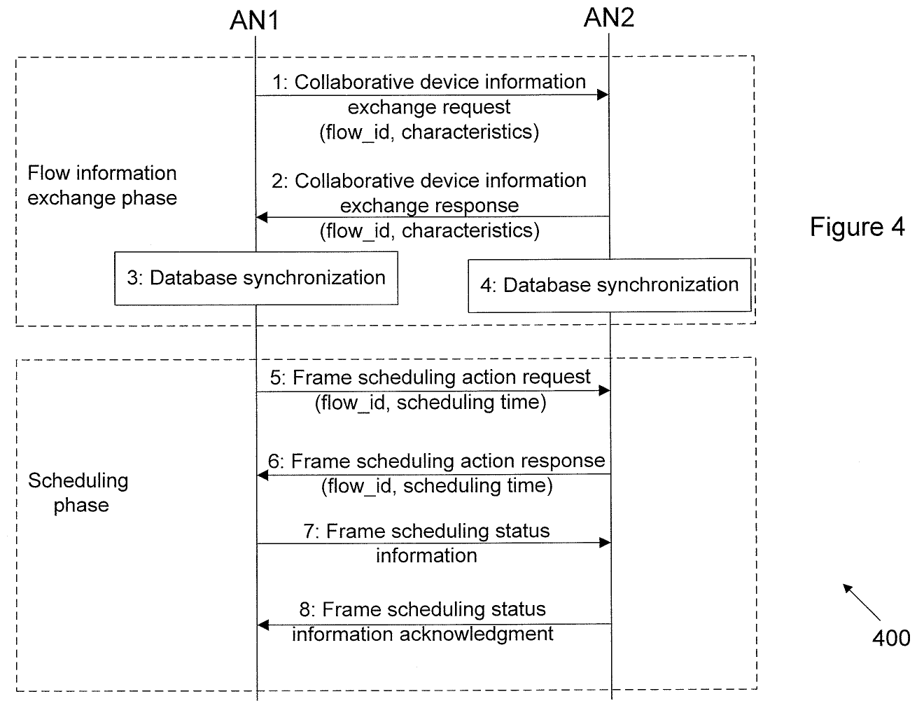

FIG. 4 shows a sequence diagram 400 which depicts the main steps of an example information exchange process between, in this example, two ANs.

Since each AN uses its own flow information database (packet data flow database), at first, in this example, the databases should be updated with the dependency information of the collaborative devices. This is performed, in this example, via a request-response process (Steps 1-2) initiated by one of the involved ANs. This process may be repeated for different ANs, depending on the number of collaborative group of devices.

The devices which belong to a common collaborative group may be determined, in some examples, on the basis of the source (programmable logic controller) address of the control frames. Also, more than two ANs may be involved in this process, depending on how many ANs serve a certain group of collaborative devices.

In this phase, the ANs may agree on a scheduling plan that describes when radio frames that carry the control frames of the collaborative devices should be scheduled. Since ANs may be synchronized on a μs scale (which may be required for the base stations), each AN knows, in this example, the common absolute time (which could be obtained, for example, from a common master clock or from a GPS receiver), so the absolute time of the frame scheduling can be defined.

After obtaining the required device dependency information, in this example, the ANs can update their own databases (Steps 3-4) with the information that there are collaborative devices which are served by one or more other ANs, as well as the scheduling plan for the involved flows may be stored.

In the scheduling phase, when all frames of a collaborative device group served by AN1 have arrived at AN1, in this example, it sends a scheduling action request to AN2 by indicating that the frames are ready to be scheduled at a given radio frame by specifying the scheduling time (Step 5). Depending on the status (arrived, delayed) of the control frames of the involved collaborative devices that are served by AN2, AN2 may acknowledge the scheduling action or request a change by specifying a new time for the scheduling (Step 6). When scheduling is completed, the involved ANs exchange, in this example, scheduling status information (successful transmission or re-transmission may be required) (Step 7-8) in order to determine if a further action is needed or the scheduling is successfully completed. Alternatively, when AN1 and AN2 have agreed on a pre-defined scheduling plan, Steps 5-8 may only be needed if a control frame cannot be scheduled according to the plan (for example when a control frame has not yet arrived) or a radio transmission problem has occurred. The scheduling plan may be modified due to any reason by performing Steps 1 and 2 again.

Support of Control Frame Scheduling without Device Collaboration

The following inputs may also be provided by the scheduling unit for the scheduler in order to avoid the loss of consecutive control frames, which could activate safety stop mechanism of the IA process.

It is to be noted that in PROFINET, typically the loss of 3 consecutive packets activates safety mechanism, which may cause the stop of the assembly cell/line.

Support of deadline scheduling: if the radio scheduler supports the deadline scheduling, the limit of the waiting time of the current control frame may be calculated dynamically based on the packet data flow database information. When the limit is exceeded, the current frame may be dropped and the next control frame belonging to the flow may be prioritized and scheduled immediately.

Support of adaptive frame selection: if all queued control frames cannot be scheduled in the current radio frame, then the frames to be scheduled may be selected based on the drop precedence and/or their waiting time/communication cycle length ratio.

Support of scheduling with HARQ re-transmission: the HARQ execution time and the communication cycle length may be compared and if the HARQ execution time exceeds the cycle length, then HARQ execution may be forced to stop and the control frame may be dropped and the next control frame may be scheduled. If the next control frame has arrived while HARQ is not executed, then HARQ may be forced to stop and the next control frame may be scheduled. If the (re-)transmission of a control frame is unsuccessful and the next frame has arrived, then this frame may be prioritized for the scheduling.

### Information for Supporting the Changes in the IA System

The above-mentioned system may be capable of constructing a communication plan of an IA system, which may contain multiple ANs. Based on the communication plan, the utilization of ANs may be calculated, so in the case of any changes (for example an installation of a new industry device with certain flow characteristics), it may be determined whether the given change can be executed without degradation of the existing communication flows.

The system as described herein has adaptivity capability, which means flexible handling of delayed frames or re-transmission. On the other hand, this adaptivity could be useful for handling any extraordinary changes in the IA system. For example, if some UEs must be connected to another AN (due, for example, to failure of their default AN or due to temporary, extreme bad radio conditions), the scheduling unit may automatically consider and endorse the changes in the scheduling process performed by the involved ANs. This may mean that the communication system may adapt to the changes without any further configuration requirements. It may happen that in the new network setup, proper scheduling may not be possible, in which case the scheduling unit may generate an alarm, for example, by specifying the problem.

The system as described herein (or one or more features of the system as described herein), which may function, in some examples, in an AN, may be implemented as a virtual network function or a set of virtual network functions. The virtual network function or the set of virtual network functions may be implemented in a cloud environment. In the cloud environment, ubiquitous access to shared pools of configurable system resources and higher-level services may be enabled for example over the Internet.

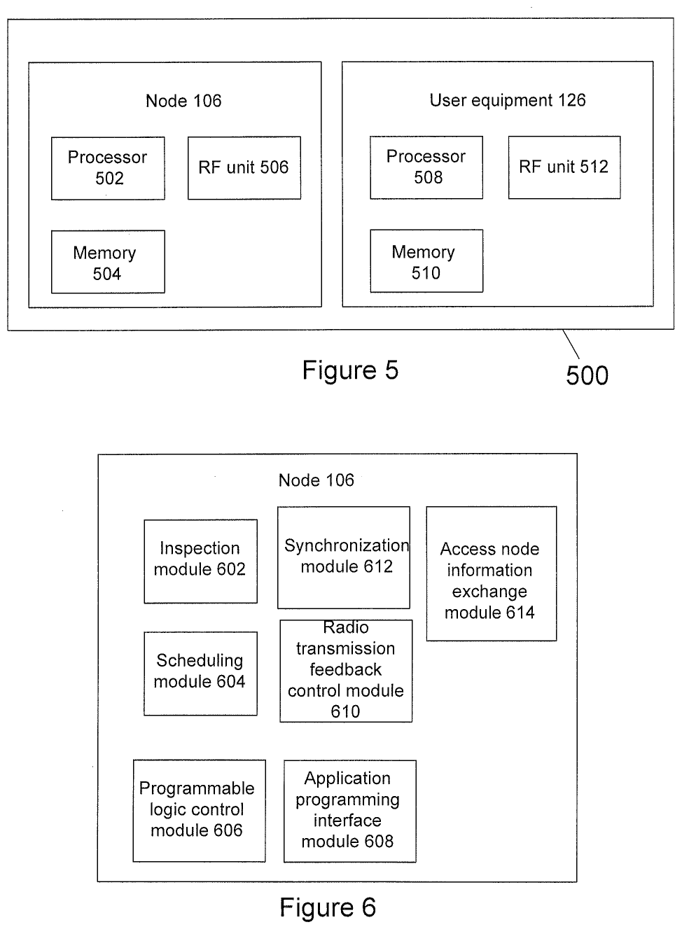

FIG. 5 shows a schematic illustration of a system 500 according to some example implementations as described herein.

In this example, the system 500 comprises a node 106 and a user equipment 126.

The node 106 comprises a processor 502, a memory 504 and a radio-frequency (RF) unit 506 via which the node 106 may communicate with the user equipment 126.

The memory 504 may store program code portions for performing the methods and example implementations as described herein, whereby the processor 502 may process the program code portions.

Furthermore, in this example, the user equipment 126 comprises a processor 508, a memory 510 and an RF unit 512.

The user equipment 126 may communicate with the node 106 and the devices of the collaborative device group via the RF unit 512. The node 106 may communicate with the user equipment via the RF unit 506, which may allow controlling the device of the collaborative device group.

It will be understood that the node 106 may be implemented as a physical computing unit as well as a virtualized computing unit, such as a virtual machine, for example. It will further be appreciated that the node 106 may not necessarily be implemented as a standalone computing unit, but may be implemented as components—realized in software and/or hardware—residing on multiple distributed computing units as well, such as in a cloud computing environment, for example.

A block diagram of a node 106 according to some example implementations as described herein is schematically illustrated in FIG. 6. The block diagram is equally applicable to a system as described herein, i.e. the various modules may be comprised in a system as described herein.

In this example, the node 106 comprises an inspection module 602 which is configured, for example, to identify a packet data flow of packet data to be transmitted by the node to a device of the collaborative device group.

The node 106 further comprises, in this example, a scheduling module 604 which is coupled to the inspection module 602, whereby the scheduling module 604 is configured to schedule the transmission of the packet data to the corresponding, respective device of the collaborative device group based on the identification of the packet data flow by the inspection module 602.

In this example, the node 106 further comprises a programmable logic control module 606 which may be coupled to the scheduling module 604 via the inspection module 602. The programmable logic control module 606 is, in this example, configured to control the devices of the collaborative device group through control frames. The system may hereby be configured to determine the operating dependency between the devices based on an inspection of a source address of the control frames.

In this example, the node 106 further comprises an application programming interface module 608. The application programming interface module 608 is, in this example, coupled to the inspection module 602 and the scheduling module 604, wherein the operating dependency between devices of the collaborative device group may be set via the application programming interface module 608.

In this example, the node 106 further comprises a radio transmission feedback control module 610 which is coupled to the scheduling module 604, wherein the radio transmission feedback control module 610 is configured to provide a control frames status, associated with a served control frame, to a packet data flow database for storage therein. The scheduling module 604 may hereby be configured to schedule subsequent transmission of packet data based on the start control frames status.

The node 106 further comprises, in this example, a synchronization module 612 which is configured, in particular when two or more access nodes are in communication with each other, to synchronize packet data transmissions from the nodes to the corresponding, respective user equipment(s) which are controlled via the respective node.

The node 106 further comprises, in this example, an access node information exchange module 614. The access node information exchange module 614 may hereby be configured to allow exchanging, for example, flow identification and/or one or more flow characteristics and/or collaborative device information between nodes. Based on this exchange, in some examples, packet data flow databases of the respective nodes may be synchronized. The access node information exchange module 614 may additionally or alternatively be configured to allow a frame scheduling action request and corresponding response and/or a frame scheduling status information and a corresponding acknowledgement to be exchanged between different nodes.

It is to be noted that any references throughout the present disclosure in relation to the scheduling unit may also relate to the scheduling control 118 shown in FIG. 1. In some example implementations, the scheduling control 118 may be integral to the scheduling unit 104. Therefore, any references throughout the present disclosure in relation to the scheduling unit are interchangeable insofar that the scheduling control may implement the corresponding functions, either alone or in combination with the scheduling unit.

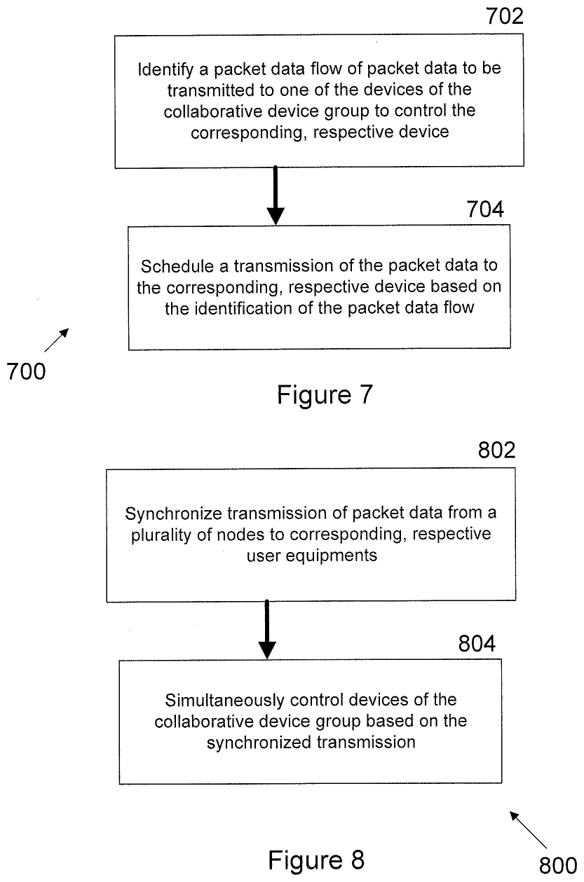

FIG. 7 shows a flowchart of a method 700 according to some example implementations as described herein.

In this example, at step 702, a packet data flow of packet data to be transmitted to one of the devices of the collaborative device group to control the corresponding, respective device is identified.

At step 704, a transmission of the packet data to the corresponding, respective device is scheduled based on the identification of the packet data flow.

FIG. 8 shows a flowchart of a method 800 according to some example implementations as described herein.

In this example, at step 802, transmission of packet data from a plurality of nodes to corresponding, respective user equipments is synchronized.

In step 804, devices of the collaborative device group are simultaneously controlled based on the synchronized transmission.

The system for Industry Automation process-aware scheduling over a wireless infrastructure as described herein considers especially collaborative industry devices. The flows may be identified and its characteristics may be obtained by using a scheduling unit (for example an SPI) and a flow information database may be built up. Based on this database and the current status of control frames, the radio scheduling may be controlled and optimized. The solution covers the cases when the collaborative devices are handled by a single UE, multiple UEs as well as by different ANs (for example base stations).

Variants and example implementations of the system as described herein allow for an increase in efficiency of the execution of an IA process by optimizing the control frame handling over the radio, while the requirements of collaborative devices are also considered.

Radio resource utilization is automatically optimized for IA traffic characteristics.

Furthermore, the system of the present disclosure may relate to a proprietary solution, but some of the functions may be standardized, for example, as 3GPP URLLC features.

The system as described herein may impact only 3GPP RAN and Core network nodes. No impact on UE(s) and no (or only minor) impact on Industry protocols and devices may occur.

Example implementations of the system as described herein may be implemented in 3GPP URLLC-related standards.

Many advantages of the present invention will be fully understood from the foregoing description, and it will be apparent that various changes may be made in the form, construction and arrangement of the system, units and devices without departing from the scope of the invention and/or without sacrificing all of its advantages. Since the invention can be varied in many ways, it will be recognized that the invention should be limited only by the scope of the following claims.

1. A node for wirelessly controlling devices of a collaborative device group in an industrial infrastructure, the node comprising:
a processor and a memory forming:
an inspection unit configured to identify a packet data flow of packet data to be transmitted by the node to one of the devices of the collaborative device group to control the corresponding, respective device;
a scheduling unit coupled to the inspection unit, the scheduling unit is being configured to schedule a transmission of the packet data to the corresponding, respective device based on the identification, by the inspection unit, of the packet data flow, the node being configured to determine an operating dependency between the devices, and the scheduling of the transmission of the packet data to the corresponding respective device being based on the operating dependency; and
a programmable logic controller coupled to the scheduling unit via the inspection unit, the programmable logic controller being configured to control the devices of the collaborative device group through control frames, and the node being configured to determine the operating dependency between the devices based on an inspection of a source address of the control frames.

2. The node as claimed in claim 1, wherein the scheduling unit is configured to schedule transmissions of respective packet data to corresponding, respective devices of the collaborative device group based on a comparison of the packet data flow identification of respective packet data flows used to control the corresponding, respective devices.

3. The node as claimed in claim 1, wherein the inspection unit is a shallow packet inspection unit.

4. The node as claimed in claim 1, wherein the node is configured to transmit the packet data to one or more user equipments via which the devices of the collaborative device group are controlled.

5. The node as claimed in claim 1, wherein, in cases where each one of the devices of the collaborative device group is associated with a corresponding, respective one of a plurality of radio bearers via which the corresponding, respective packet data is transmitted to the corresponding, respective device, the identification of the packet data flow to the corresponding, respective device is based on the corresponding, respective one of the plurality of radio bearers.

6. The node as claimed in claim 1, wherein, in cases where at least two of the devices share a single radio bearer, the identification of the packet data flow to a corresponding, respective one of the devices is based on at least one of:
a detection of an identifier which is carried by a control frame, wherein each one of the devices of the collaborative device group is associated with a corresponding, respective identifier; and
a detection of a destination address of a corresponding, respective one of the devices of the collaborative device group.

7. The node as claimed in claim 1, wherein the inspection unit is further configured to determine a characteristic of the identified packet data flow, and wherein the scheduling unit is configured to schedule the transmission of the packet data to the corresponding, respective device based on the determined characteristic of the identified packet data flow.

8. The node as claimed in claim 7, wherein the characteristic comprises a communication cycle length of a communication between the node and the corresponding, respective device.

9. The node as claimed in claim 8, wherein the communication cycle length is set on a per-device basis.

10. (canceled)

11. (canceled)

12. The node as claimed in claim 1, wherein the processor and memory further form an application programming interface coupled to the inspection unit and the scheduling unit, wherein the operating dependency is set via the application programming interface.

13. The node as claimed in claim 12, wherein at least two of the devices are controlled by different, respective programmable logic controllers, and wherein the setting, via the application programming interface, of the operating dependency between the devices comprises simultaneously controlling the programmable logic controllers.

14. The node as claimed in claim 1, wherein the node is configured to prioritize transmission of a first packet data for a first device control operation over transmission of a second packet data for a second device control operation during the packet data transmission scheduling when a first priority of the first device control operation is higher than a second priority of the second device control operation.

15. The node as claimed in claim 1, further comprising a packet data flow database coupled to the inspection unit and the scheduling unit, wherein the packet data flow database is configured to receive information relating to the packet data flow from the inspection unit and to store the information, and wherein the scheduling unit is configured to schedule the transmission of the packet data based on the information stored in the packet data flow database.

16. The node as claimed in claim 15, wherein the processor and memory further form a radio transmission feedback control unit coupled to the scheduling unit and the packet data flow database, wherein the radio transmission feedback control unit is configured to provide a control frame status, associated with a served control frame, to the packet data flow database for storage in the packet data flow database, and wherein the scheduling unit is configured to schedule subsequent transmission of packet data based on the stored control frame status.

17.-20. (canceled)

21. The node as claimed in claim 1, wherein, in cases where the devices are served by a single user equipment, the scheduling unit is configured to schedule the transmission of control frames for corresponding, respective devices of the collaborative device group in a single radio frame.

22. The node as claimed in claim 1, wherein, in cases where the devices are served by two or more corresponding, respective user equipments, the scheduling unit is configured to schedule transmission of control frames for the respective devices in corresponding, respective control frames at the same time.

23. The node as claimed in claim 21, wherein, in cases where a control frame of one of the devices is delayed, the scheduling unit is configured to determine whether non-delayed control frames are to be transmitted one of as scheduled and transmitted at a later point of time.

24. The node as claimed in claim 22, wherein the node is configured to compare a HARQ execution time with a communication cycle length of the packet data flow and to stop a HARQ execution when it is determined that the HARQ execution time exceeds the communication cycle length of the packet data flow.

25. A system comprising two or more nodes, each node wirelessly controlling devices of a collaborative device group in an industrial infrastructure, each node comprising:
a processor and a memory forming:
an inspection unit configured to identify a packet data flow of packet data to be transmitted by the node to one of the devices of the collaborative device group to control the corresponding, respective device;
a scheduling unit coupled to the inspection unit, the scheduling unit being configured to schedule a transmission of the packet data to the corresponding, respective device based on the identification, by the inspection unit, of the packet data flow, the node being configured to determine an operating dependency between the devices, and the scheduling of the transmission of the packet data to the corresponding respective device being based on the operating dependency; and
a programmable logic controller coupled to the scheduling unit via the inspection unit, the programmable logic controller being configured to control the devices of the collaborative device group through control frames, and the node being configured to determine the operating dependency between the devices based on an inspection of a source address of the control frames:
each of the nodes being configured to transmit packet data to one or more corresponding, respective user equipments via which the system controls the devices of the collaborative device group.

26.-34. (canceled)

35. A method for wirelessly controlling devices of a collaborative device group in an industrial infrastructure, the method comprising:
identifying a packet data flow of packet data to be transmitted to one of the devices of the collaborative device group to control the corresponding, respective device; and
scheduling a transmission of the packet data to the corresponding, respective device based on the identification of the packet data flow, an operating dependency between the devices being determined, and the scheduling of the transmission of the packet data to the corresponding respective device being based on the operating dependency, and the devices of the collaborative device group are controlled through control frames, the operating dependency between the devices being determined based on an inspection of a source address of the control frames.

36.-38. (canceled)
